(19) United States
(12) Patent Application Publication
(10) Pub. No.: US 2005/0254515 A1
(43) Pub. Date: Nov. 17, 2005

(54) DSL modem apparatus and control method for DSL modem apparatus

(75) Inventors: Takashi Suzuki, Kanagawa (JP); Genzo Takagi, Saitama (JP); Yoshinori Takahashi, Saitama (JP); Toshiko Nishida, Kanagawa (JP); Akihiro Sobue, Tokyo (JP); Nobuhiko Noma, Kanagawa (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/115,291

(22) Filed: Apr. 27, 2005

(30) Foreign Application Priority Data
May 11, 2004 (JP) 2004-141545

(51) Int. Cl. H04L 12/56

(52) U.S. Cl. 370/463

(57) ABSTRACT

After establishing a connection between an ATU-C and an ATU-R and having a state where data communication is enabled, the ATU-R checks a packet that flows through a network at the user side. When there is no packet addressed to the ATU-R for a predetermined time period, the ATU-R transmits, to the ATU-C, a request to transition to an energy-save mode. The ATU-C and AUT-R determines a parameter to be used for the energy save mode, the parameter enabling a number of carriers and/or transmission power to be decreased compared to the ones in a normal mode. Using the determined parameter, a state in which data communication is enabled is maintained.

### BACKGROUND OF THE INVENTION

1. Field of the Invention

The present invention relates to a DSL modem apparatus and a control method for the same, to which the xDSL technology is applied, the technology enabling a high speed communication of several M bits/second even when a cupper wire cable is used for subscriber lines.

2. Description of Related Art

There is an increasing need for high speed access lines due to the popularity of the Internet. At the same time, more optical fiber cables are introduced to the backbone of the communication carriers, which make use of super high speed lines (gigabit class) in the backbone. However, there are cases where a metal cable for an ordinary telephone is still used for a subscriber line that connects a user's home and a carrier center. Therefore, the xDSL technology has been introduced to enable the high speed communication of several M bits/second via a metal cable.

The ADSL method is one example of the xDSL technology. The ADSL method uses a carrier frequency of 35 kHz or more, which is much higher than a frequency band for telephones (4 kHz or less). Accordingly, it is possible to perform the high speed communication using a telephone line, without hindering the function of the ordinary telephone.

When the ADSL is used, it is common to set up ADSL modems at both sides of the metal cable that connects the user's home and the carrier center. When the ADSL modem setup at the ATU-R side (hereafter referred to as “ATU-R”) is turned on, the ATU-R and the ADSL modem setup at the ATU-C side (hereafter referred to as “ATU-C”) establish synchronization, exchange capabilities, determine communication parameters according to the protocols by the ITU-T recommendation, and thereafter enter into a data communication phase (Showtime) (e.g., Related Art 1).

Recently, it has become a mainstream to have a constant connection from a home-use personal computer (PC) to the Internet. In case of an ADSL Internet connection, the center separates signals prior to an exchange stage to enable the connection to the Internet via a router. The ATU-R operates during the data communication and even in a period where the PC is turned off, in order to receive a control signal transmitted from the ATU-C (e.g., a pilot signal for synchronization). G.dmt, which is one of the ITU-T recommendations related to DSL communication, transmits control signals and data using 26 carriers (bins) in the low frequency band for the upstream (communication from the ATU-R to the ATU-C) and receives control signals and data using 223 carriers (bins) in the high frequency band for the downstream (communication from the ATU-C to the ATU-R). Therefore, after power is turned on, all bins assigned to the downstream maintain a state in which signals can be received, while all bins assigned to the upstream maintain a state in which signals can be transmitted.
[Related Art 1] Japanese Patent Laid Open Publication 2003-0873480

However, a certain amount of electric power goes to waste when the ATU-R is left in an operatable condition during the period in which the PC is turned off. The user may turn off the ADSL modem every time the PC is turned off in order to save energy. However, there are situations where apparatuses other than the PC (e.g., IP telephone) are connected to the ATU-R via the router. These situations can be problematic, since when the ATU-R is turned off, for example, the IP telephone cannot receive calls.

### SUMMARY OF THE INVENTION

The present invention addresses the above-described problem. The purpose of the invention is to provide a DSL modem apparatus and a control method for the same, which can automatically transition to an energy-save mode while maintaining a communication function, when data communication is not performed, thereby saving the energy consumption.

In the present invention, a DSL modem apparatus at a user side, the apparatus establishing a connection with a DSL modem apparatus at a center side and having a state where data communication is enabled, checks a packet that flows through a network at the user side. When there is no packet addressed to the DSL modem apparatus at the user side for a predetermined time period, the DSL mode apparatus transitions to an energy-save mode. During the energy-save mode, a number of carriers and/or transmission power are decreased compared to the ones in a normal mode.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a functional block diagram illustrating an ADSL modem apparatus according to an embodiment of the present invention;

FIG. 2 illustrates a network configuration between an ATU-C and an ATU-R;

FIG. 3 illustrates a normal sequence between the ATU-C and the ATU-R;

FIG. 4(a) illustrates carrier locations during a normal mode;

FIG. 4(b) illustrates carrier locations during energy-save mode 1;

FIG. 5(a) illustrates carrier locations during energy-save mode 2;

FIG. 5(b) illustrates carrier locations during energy-save mode 1+2; and

FIG. 6 is an energy saving sequence between the ATU-C and the ATU-R.

### DETAILED DESCRIPTION OF PREFERRED EMBODIMENTS

An ADSL modem apparatus according to the embodiment of the present invention is explained in the following, in reference to the above-described drawings.

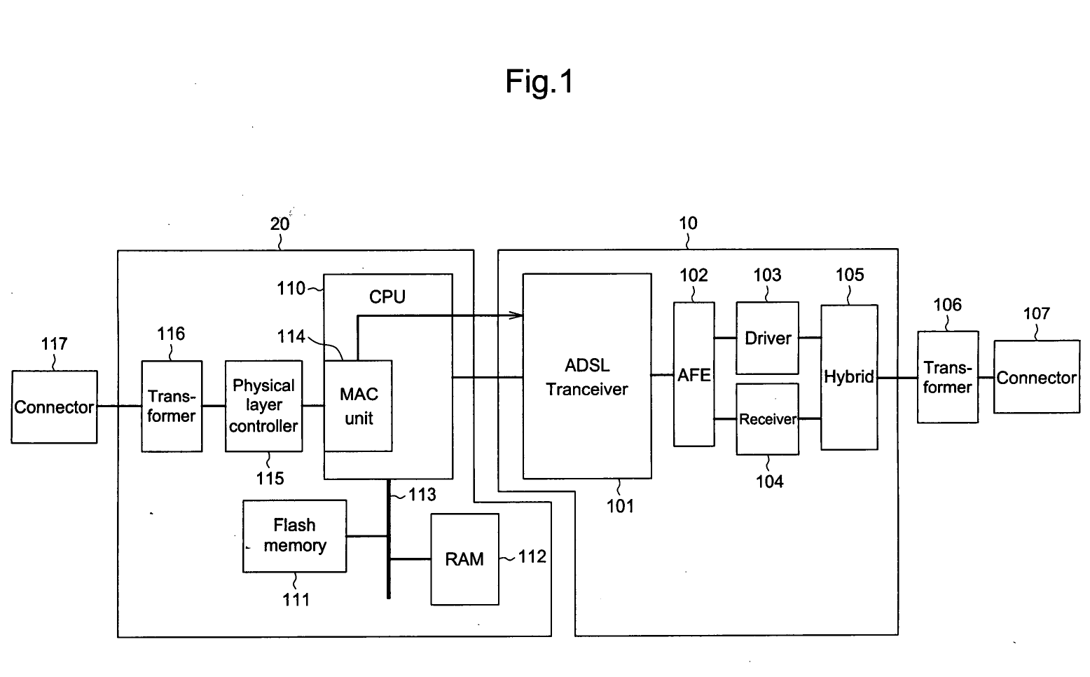

FIG. 1 is a functional block diagram of an ADSL modem apparatus that is located at a user's home side. The ADSL modem apparatus in FIG. 1 includes ADSL communicator 10 and ADSL host section 20. ADSL communicator 10 includes ADSL transceiver 101 that performs a handshake sequence, initialization sequence, and communication control for a data communication phase. ADSL transceiver 101 performs a control of that decreases the energy consumption while maintaining the communication function during the energy-save mode. Driver 103 and receiver 104 are connected to ADSL transceiver 101, via AFE (analog front end) 102 that performs AD/DA conversion. Driver 103 is a circuit that amplifies a transmission signal (analog) output from AFE 102 to a level that is suitable for a metal cable (subscriber line). Receiver 104 is a circuit that converts the power of a reception signal received from the metal cable (subscriber line) to a level suitable for AFE 102. Driver 103 and receiver 104 are connected to connector 107, via hybrid 105 and transformer 106, the connector being physically connected to the metal cable (subscriber line).

ADSL host section 20 also includes CPU 110 for an interface with an LAN (Local Area Network; such as an Ethernet located at the user's home). In this embodiment, the Ethernet is connected to the ADSL modem apparatus. CPU 110 monitors packets that are received via the Ethernet. When a packet directed to ADSL modem apparatus 404 is not received for a predetermined time period (e.g., 10 minutes), CPU 110 transmits an instruction to ADSL transceiver 101 to transition to the energy-save mode. When a packet directed to ADSL modem apparatus 404 is received via the Ethernet during the energy-save mode, CPU 110 transmits an instruction to ADSL transceiver 101 to cancel the energy-save mode. Flash memory 111 and RAM 112 are connected to CPU 110 via bus 113. CPU 110 internally houses MAC unit 114 that performs processes such as MAC frame assembly/disassembly (for the flow on the Ethernet) and MAC address recognition. The MAC address of MAC frame is used to determine whether a packet is addressed to ADSL modem apparatus 404. MAC unit 114 is connected to transformer 116 via physical layer controller 115, the physical layer controller 115 controlling, in the physical layer, modulation and other operations employed by the Ethernet. Connector 117 is connected to the network side of transformer 116. A cable of the Ethernet is physically connected to connector 117. A router is connected beyond connector 117.

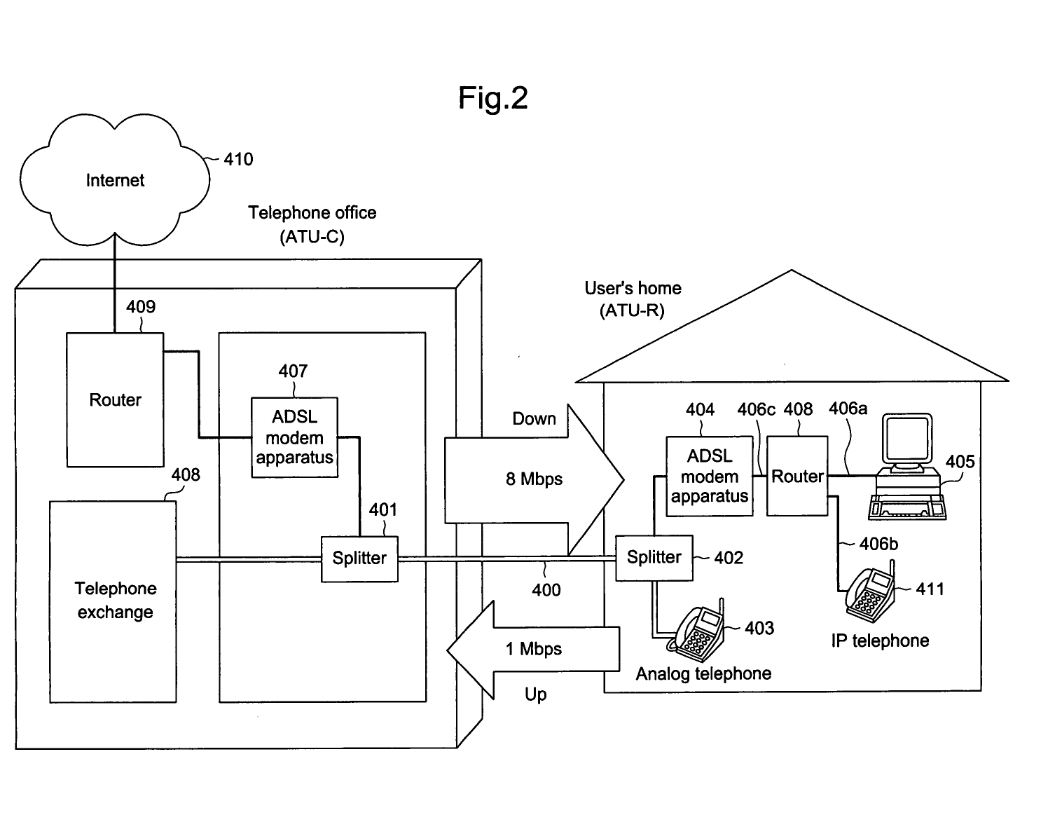

FIG. 2 illustrates an example of a system configuration having the ATU-C and ATU-R, to which the above described ADSL modem apparatus is applied. In general, metal cable 400 connects the ATU-C (center side) and ATU-R (user's home side), the cable having already been used as a general subscriber line. At both ends of metal cable 400, splitters 401 and 402 are attached. Splitters 401 and 402 split the communication band into a voice band to be used for the telephone line and a data communication band to be used for the ADSL data communication. If there is no need to split the communication band, the splitters are not necessary. Analog telephone 403 and ADSL modem apparatus 404 are connected to splitter 402 at the ATU-R side. ADSL modem apparatus 404 has the configuration shown in FIG. 1. PC 405 and IP telephone 411 located at the ATU-R side are connected to router 408 via Ethernet cables 406a and 406b respectively. Router 408 is connected to ADSL modem apparatus 404 via Ethernet cable 406c, which means that one end of Ethernet cable 406c is physically connected to connector 117 shown in FIG. 1.

ADSL modem apparatus 407 and telephone exchange 408 are connected to splitter 401 at the ATU-C side. Signals for the voice band split by splitters 401 is output to telephone exchange 408, while signals for the ADSL communication band (set higher than the voice band) is output to ADSL modem apparatus 407. Although ADSL modem apparatus 407 has the basic configuration shown in FIG. 1, ADSL modem apparatus 407 at the center side is not turned off, as a basic rule, in order to respond to any detected signals transmitted from the ATU-R side. ADSL modem apparatus 407 is connected to Internet 410 via router 409.

Next, an operation of the present embodiment having the above described configuration is illustrated in the following.

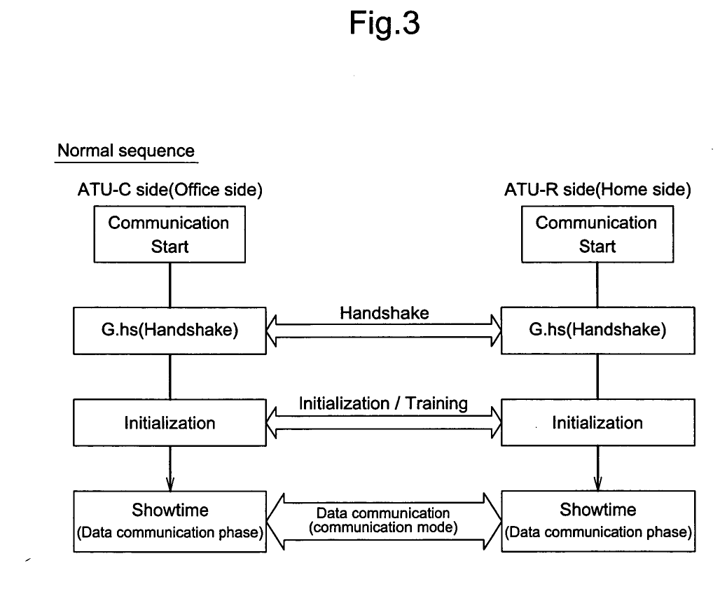

FIG. 3 illustrates a normal sequence starting from when an ADSL modem apparatus is turned on and until a data communication is established. When ADSL modem apparatus 404 at the ATU-R side is turned on, ADSL modem apparatus 404 at the ATU-R side and ADSL modem apparatus 407 at the ATU-C side perform a handshake sequence, in which types and capabilities of both sides are exchanged. When the handshake sequence is completed, an initialization sequence is performed. In the initialization sequence, the line condition is checked and trained, and a communication parameter for the ADSL communication is determined. When the initialization sequence is completed, the data communication is enabled. ADSL transceivers 101 in both ADSL modem apparatuses 404 and 407 mainly perform the above handshake and initialization sequences.

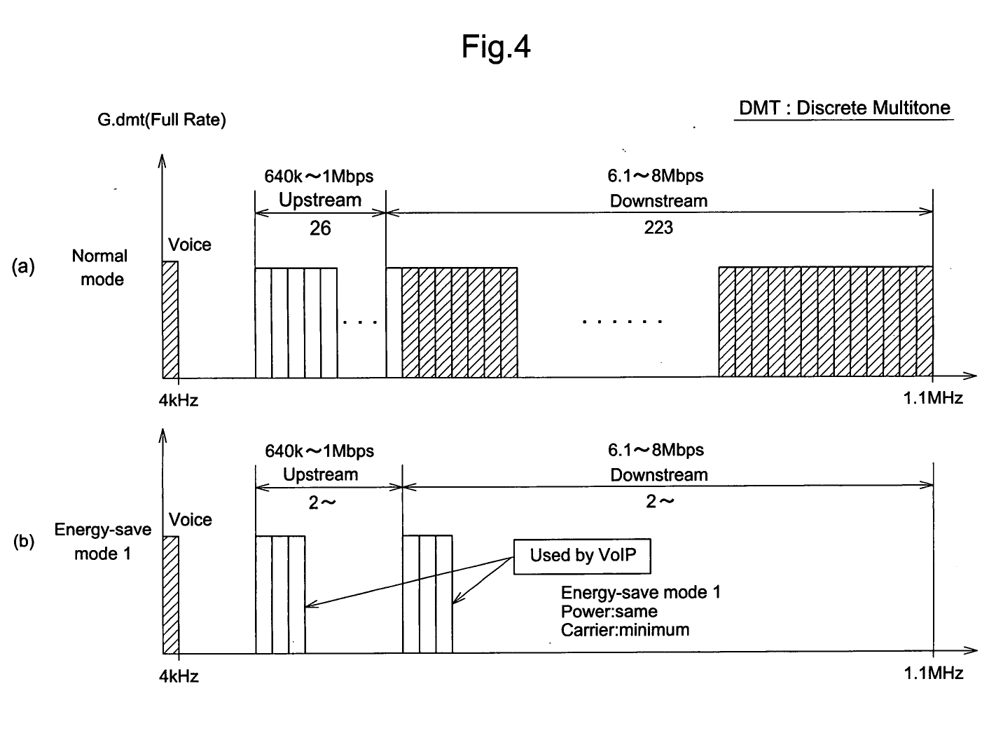

FIG. 4(a) illustrates carriers (bins) used for the upstream and downstream of the ATU-R, during the normal mode, and a power setting for each carrier. During the normal mode, the communication is performed with all carriers (bins) used for the upstream and downstream having the maximum power, in order to exhibit the maximum communication capacity.

Conventionally, as shown in FIG. 4(a), both ADSL modem apparatuses 404 and 407 maintain a state in which the data communication is enabled, with all carriers (bins) used for the upstream and downstream having a predetermined value, even during a period in which data transmission/reception is not generated.

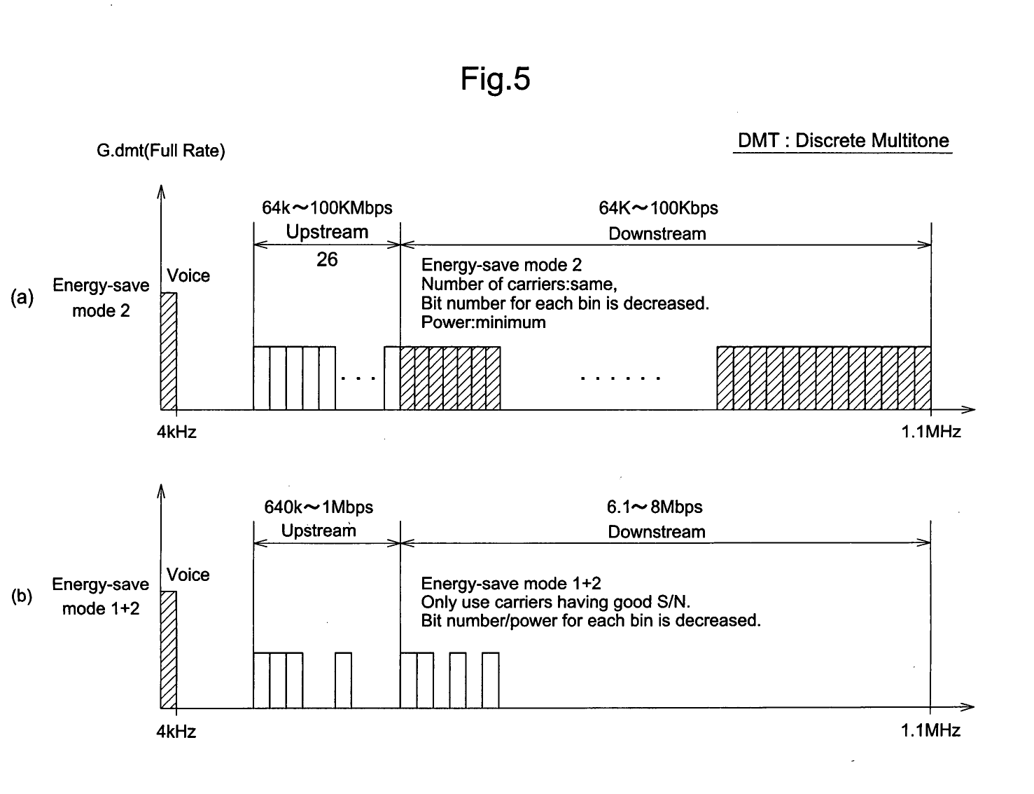

In the present embodiment, when data transmission/reception is not generated for a predetermined time period, the energy consumption is decreased by transitioning into the energy-save mode, where a number of carriers (bins) is decreased to a level with which the minimum communication capacity is maintained as shown in FIG. 4(b); the transmission power of each carrier (bin) is decreased to a level where the minimum communication capacity is maintained as shown in FIG. 5(a); or the decrease in the number of carriers (bins) and the decrease in the transmission power are combined as shown in FIG. 5(b). In the method shown in FIG. 5(b), 4 carriers having good S/N are chosen from the left side of each stream (upstream and downstream) as shown in the figure.

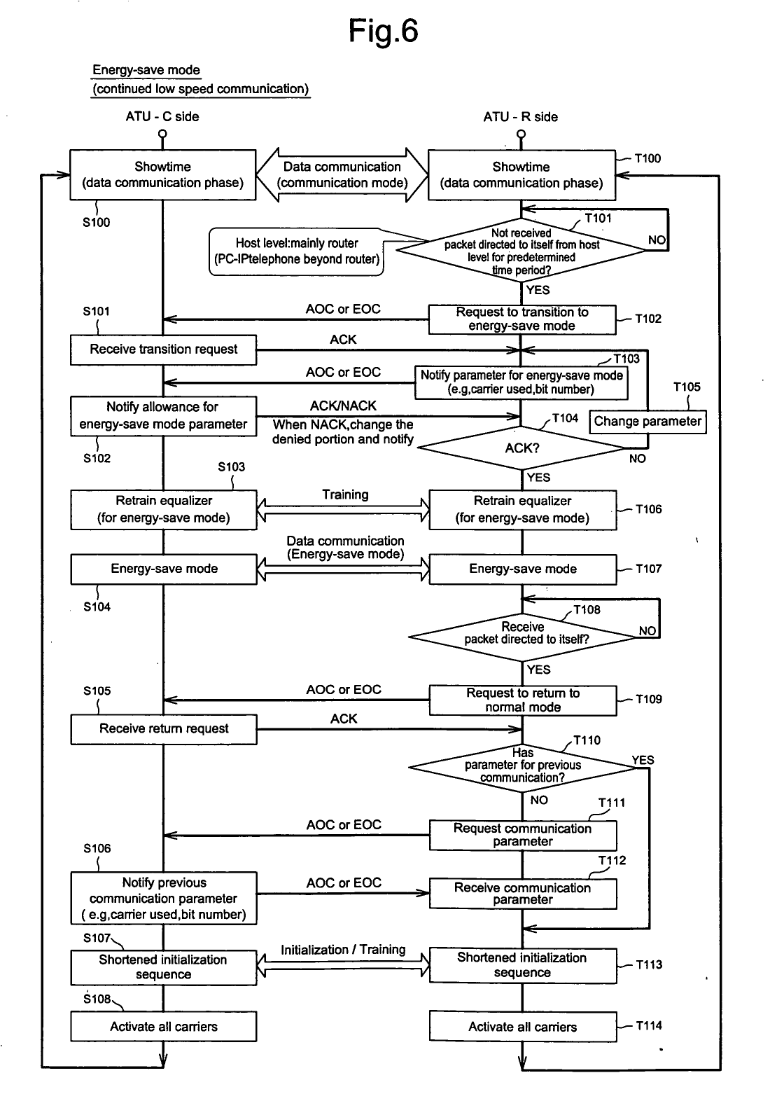

FIG. 6 illustrates a sequence of a transition from the normal mode into the energy-save mode, and from the energy-save mode into the normal mode. In this example, the ATU-C and ATU-R have already been performing data communication in the data communication phase (Showtime) (T100 & S100). In the normal mode, the data communication is performed using the number of carriers and the maximum transmission power shown in FIG. 4(a).

During the normal mode above, CPU 110 of the ATU-R detects a packet addressed to ADSL modem apparatus 404 from the MAC address detected at MAC unit 114. When performing data communication, via the ATU-R, from PC 405 or IP telephone 411 connected to the Ethernet at the user's home, the packet transmitted from PC 405 or IP telephone 411 is addressed to ADSL modem apparatus 404 on the Ethernet. Accordingly, it is possible to determine whether PC 405 or IP telephone 411 is currently in communication by checking the MAC address included in the packet, the packet being captured from the Ethernet. The normal mode is maintained when each packet addressed to ADSL modem apparatus 404 is being received within a predetermined interval of time (e.g., less than 10 minutes). Using the connection configuration shown in FIG. 2, the packet addressed to ADSL modem apparatus 404 will not be received when PC 405 or IP telephone 411 is not being used.

When CPU 110 of the ATU-R determines that each packet addressed to ADSL modem apparatus 404 is not being received within a predetermined interval of time (T101), CPU 110 transmits, to the ATU-C, a request to transition to the energy-save mode (T102). In particular, CPU 110 outputs the request to transition to the energy-save mode to ADSL transceiver 101. Upon receiving the request to transition to the energy-save mode, ADSL transceiver 101 notifies the ATU-C of the request to transition to the energy-save mode, using an AOC or EOC. The AOC and EOC are control signals used to exchange statuses between ADSL modem apparatuses.

Upon recognizing, from the received AOC/EOC, the request to transition to the energy-save mode, the ATU-C accepts the transition request (S101). Then, ATU-C transmits an ACK to the ATU-R, indicating the reception of the transition request.

Upon detecting the ACK from the ATU-C, the ATU-R notifies the ATU-C of a communication parameter to be used in the energy-save mode, using an AOC or EOC (T103). The communication parameter to be used in the energy-save mode includes a carrier to be used (index number) or a bit number to be loaded on each carrier. For example, as shown in FIG. 4(b), when 3 carriers are used for each stream (upstream and downstream), the index number for each carrier is notified to the opposing side. In addition, as shown in FIG. 5(a), when the transmission power is decreased by lowering the bit number to be loaded on each carrier but using the same number of carriers as the normal mode, the bit number is notified. Further, as shown in FIG. 5(b), when the transmission power is decreased by both selecting several carriers having good S/N for each stream (upstream and downstream) and decreasing the bit number to be loaded on each carrier, the carriers (index numbers) to be used and the bit number are notified.

The ATU-C detects the parameter for the energy-save mode, the parameter being notified by the ATU-R, through the AOC/EOC. Then, ATU-C detects whether to accept the notified parameter as is. For example, when the parameter specifies a carrier that cannot be used for a certain reason at the ATU-C, the ATU-C denies the carrier. When the parameter includes a portion to be denied, the ATU-C returns the same using an NACK. When all the parameter can be accepted, the ATU-C returns an ACK (S102).

Upon receiving the NACK (T104), the ATU-R changes the rejected portion of the parameter (T105). As a method to change the rejected parameter, several parameters proposed to be used during the energy-save mode can be selected in advance, so that the ATU-C can be notified of one of the proposed parameters.

When the ATU-R and ATU-C confirm the parameter to be used during the energy-save mode (T104 & S102), a training for equalizers at both sides is performed, under the communication condition based on the parameter (T106 & S103). ADSL transceiver 101 has an equalizer that includes a DSP. A gain amount of each bin in the equalizer is once adjusted to suit the normal mode communication during the initialization sequence (training). Depending on the need, the training may include other items to be adjusted in addition to the gain amount.

For example, as shown in FIG. 4(b), when 3 carriers are used for each stream (upstream and downstream), the carriers are trained in order to determine the gain amount. In addition, as shown in FIG. 5(a), when the transmission power is decreased by lowering the bit number to be loaded on each carrier but using the same number of carriers, the training is performed using the decreased transmission power for determining the gain amount for each carrier. Further, as shown in FIG. 5(b), when the transmission power is decreased by both selecting carriers having good S/N and decreasing the power in each carrier, the training is performed under such conditions.

When the training of the equalizers under the communication condition based on the parameter is completed, the ATU-R and ATU-C transition into the energy-save mode (T107 & S104). In the energy-save mode, even when there is no data transmission request from the host, pilot signals are periodically exchanged to maintain the synchronization.

The ATU-R constantly monitors for a reception packet directed to ADSL modem apparatus 404 from the host (T108), even after the transition into the energy-save mode. CPU 110 retrieves a packet flowing in the Ethernet and checks the MAC address of the packet. When the packet is directed to ADSL modem apparatus 404 (T108), CPU 10 transmits a request, to the ATU-C, to return to the normal mode (T109). The request to return to the normal mode can be made by using an AOC/EOC.

The ATU-C uses carriers determined at S102 during the energy-save mode (S104). When the ATU-R transmits a request to return to the normal mode, ATU-C receives the return request and transmits an ACK (S105).

The ATU-R determines whether the parameter used during the previous communication (normal mode) is stored (T110). When the parameter used during the previous communication is not stored, the ATU-R transmits a request to the ATU-C for the communication parameter using the AOC/EOC (T111).

Upon receiving the request for the communication parameter used during the previous communication from the ATU-R, the ATU-C notifies the ATU-R of the requested communication parameter (S106). Using the parameter notified from the ATU-C (T112) or using the pre-stored communication parameter used during the previous communication, the ATU-R performs the initialization sequence with the ATU-C (T113 & S107).

The initialization sequence executed at T113 and S107 can be shortened by applying the communication parameter from the previous communication, thereby omitting a portion of the sequence. Or, when the parameter that is exactly the same as the communication parameter from the previous communication is applied to the entire sequence, it is possible to directly move to the normal mode, without executing the initialization sequence.

When the communication parameter is determined, the ATU-R and ATU-C utilize all carriers and transition to the normal mode (T114 & S108).

According to the embodiment of the present invention, When PC 405 or IP telephone 411 at the ATU-R side does not perform the data communication for a predetermined time period, the ATU-R transitions into an energy-save mode from a normal mode in order to conserve energy. Therefore, it is possible to reduce the energy consumption at a user's home, while maintaining communication functions.

In the above description, the ADSL method is used for the illustration. However, the present invention can be applied to other DSL methods.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2004-141545 filed on May 11, 2004, entire content of which is expressly incorporated by reference herein.

1. A DSL modem apparatus comprising:
a communication controller that establishes a connection with a DSL modem apparatus at a center side and provides a state in which data communication is enabled; and
a host controller that checks a packet flowing in a network at a user side and instructs said communication controller to transition to an energy-save mode when there is no packet addressed to the DSL modem apparatus at the user side for a predetermined time period, and
wherein said communication controller, in the energy-save mode, decreases at least a number of carriers and transmission power, compared to a normal mode.

2. The DSL modem apparatus according to claim 1, wherein said communication controller transmits, when receiving an instruction from said host controller to transition to the energy-save mode, a request to transition to the energy-save mode to the DSL modem apparatus at the center side, and thereafter determines a parameter with the DSL modem apparatus at the center side, the parameter being used during the energy-save mode.

3. The DSL modem apparatus according to claim 2, wherein said communication controller trains an equalizer with the parameter to be used during the energy-save mode, prior to transitioning to the energy-save mode.

4. The DSL modem apparatus according to claim 1, wherein said host controller checks a packet that flows in the network at the user side even during the energy-save mode, and instructs said communication controller to transition to the normal mode when detecting a packet addressed to the DSL modem apparatus at the user side.

5. The DSL modem apparatus according to claim 4, wherein said communication controller shortens, when receiving the instruction from said host controller to transition to the normal mode, an initialization sequence by applying a parameter from a previous communication, the parameter being stored in advance.

6. A method for controlling a DSL modem apparatus, the apparatus being at a user side, establishing a connection with a DSL modem apparatus at a center side, and being in a state in which data communication is enabled, the method comprising:
checking a packet that flows in a network at the user side;
transitioning to an energy-save mode when there is no packet addressed to the DSL modem apparatus at the user side for a predetermined time period; and
decreasing, in the energy-save mode, at least one of a number of carriers and transmission power, compared to a normal mode.

7. An energy-saving communication method comprising:
establishing a connection between a DSL modem apparatus at a center side and a DSL modem apparatus at a user side, and providing a state in which data communication is enabled;
checking, by the DSL modem apparatus at the user side, a packet that flows in a network at the user side;
transmitting a request to transition to an energy-save mode to the DSL modem apparatus at the center side, when there is no packet addressed to the DSL modem apparatus at the user side for a predetermined time period;
determining, between the DSL modem apparatus at the center side and the DSL modem apparatus at the user side, a parameter that is used during the energy-save mode, the parameter having at least a decreased number of carriers and transmission power compared to a normal mode; and
maintaining the state in which data communication is enabled, by using the determined parameter.
